(19) United States
(12) Patent Application Publication
(10) Pub. No.: US 2009/0100727 A1
(43) Pub. Date: Apr. 23, 2009

(54) Signboard

(76) Inventor: Chun-Ming Chen, Yung Kung City (TW)

Correspondence Address: PRO-TECHTOR INTERNATIONAL SERVICES, 20775 NORADA CT., SARATOGA, CA, 95070, US

(21) Appl. No.: 12/185,379

(22) Filed: Aug. 4, 2008

(30) Foreign Application Priority Data
Oct. 22, 2007 (TW) 096217657

(51) Int. Cl. G09F 13/18; H05B 33/00

(52) U.S. Cl. 40/546

(57) ABSTRACT

A LED signboard includes a transparent base panel carrying a design of a fluorescent substance and having a groove formed in the back side and extending around the border, and a programmable controller-controlled LED light set mounted in the groove of the transparent base panel to hold LEDs in a parallel manner relative to the extending direction of the transparent base panel so that the LEDs emit light into the transparent base panel to illuminate the design in the transparent base panel subject to a predetermined order and frequency and at the same time the glow of the LEDs goes to the outside of LED signboard to show an lacing lighting effect.

### BACKGROUND OF THE INVENTION

1. Field of the Invention

The present invention relates to signboards and more particularly, to a LED signboard that has a LED light set mounted inside a transparent base panel that carries a design.

2. Description of the Related Art

A signboard is a board carrying a sign or notice and used for advertising purpose to attract people's attention. A signboard may be used with a light source. The light source for this purpose may be comprised of one or a number of cold cathode fluorescent 1amps, incandescent lamp bulbs, or fluorescent lamp tubes. The lamp bulbs or lamp tubes may be mounted on the inside of the signboard, or on the outside of the signboard and controlled to emit light subject to a predetermined order and frequency. Neon lamps may be used with a signboard, and controlled to produce a flashing effect. These light sources consume much electricity during operation. Therefore, regular signboards usually use city power supply to provide the necessary working voltage to the light source. There are signboards using a battery to provide the light source with the necessary working voltage. However, the power of the battery will become low soon because the light source of a conventional signboard consumes much electricity during working. When the power of the battery is low, the battery must be recharged or replaced with a new one. Further, conventional signboards are commonly heavy and big-sized, and not freely movable. Nowadays, many edge light signboards are commercially available These edge light signboards use LEDs to produce light for the advantages of low consumption of power supply and low heat level.

FIGS. 1 and 2 illustrate a LED signboard according to the prior art. According to this design, the LED signboard comprises a LED light source 10, an open frame 20, and a flat panel 30 carrying a sign 40. The open frame 20 holds flat panel 30 in place. The LED light source 10 is mounted in the frame 20 box and spaced around the flat panel 30. When the LED light source 10 is switched on, it emits light toward the inside of the flat panel 30, and the open frame 20 blocks lateral glow. When viewing from the front side of the signboard, a person cannot see any glow around the periphery of the signboard. In order to enhance the visual effect, through holes 201 may be formed in the open frame 20 so that a number of the color LEDs of the LED light source 10 can be positioned in the through holes 201 to emit different colors of light toward the outside of the signboard (sec FIG. 2A). However, this arrangment requires a relatively greater number of LEDs. The processing of the through holes 201 and the installation of added LEDs greatly increase the cost. Therefore, an improvement is necessary.

### SUMMARY OF THE INVENTION

The present invention has been accomplished to provide a LED signboard that eliminates the aforesaid drawbacks. It is the main object of the present invention to provide a LED signboard, which allows the glow of the LEDs thereof to be dispersed outwards, simulating the functioning of an edge light and enhancing the advertising or signally visual effect. It is another object of the present invention to provide a LED signboards which utilizes easily machinable acryl or other plastics materials as a base panel with grooves formed thereon for holding LED light source means for illuminating the design carried on the base panel.

To achieve these and other objects of the present invention, the LED signboard comprises a transparent base panel, which can carry a design and has at least one groove formed in at least one of the front and back sides thereof, and a LED light set mounted in the at least one groove of the transparent base panel to hold LEDs in a parallel manner relative to the extending direction of the transparent base panel so that the LEDs emit light into the transparent base panel to illuminate the design in the transparent base panel and the glow of the LEDs goes to the outside of LED signboard to show an lacing lighting effect when the LED light set is switched on.

Further, the at least one groove can be formed in the back side of the transparent base panel, the front side of the transparent base panel, or both the front and back sides of the transparent base panel. The at least one groove can also be made to show any of a variety of patterns.

Further, the LED light set comprises at least one substrate strip mounted in the at least one groove, and a plurality of light emitting diodes electrically connected to the at least one substrate strip and extending in parallel to the extending direction of the transparent base panel and adapted for emitting light into the transparent base panel. The at least one substrate strip can be mounted in the at least one groove either in parallel to the extending direction of the transparent base panel or in a direction perpendicular to the extending direction of the transparent base panel. After installation of the at least one substrate strip in the at least one groove, the light emitting diodes must be kept in parallel to the extending direction of the transparent base panel so that the light emitting diodes can emit light into the transparent base panel in a parallel manner relative to the extension direction of the transparent base panel.

In one embodiment of the present inventions the LED light set comprises a plurality of LED groups mounted in the at least one groove of the transparent base panel and arranged around the border of the transparent base panel. Each LED group of the LED light set comprises a number of light emitting diodes of one same color. Further, a programmable controller is installed for controlling the flashing pattern and the flashing frequency of said light emitting diodes of said LED groups.

In another embodiment of the present inventions the LED light set comprises a plurality of different colors of light emitting diodes mounted in the at least one groove of the transparent base panel and arranged around the border of the transparent base panel, and a programmable controller is installed for controlling the flashing pattern and the flashing frequency of the light emitting diodes of the LED groups.

Further, a back plate may be covered on the back side of the transparent base panel. In this case, a packing frame can be fastened to the transparent base panel and the back plate around the border area. Further, the back side of the transparent base panel can be treated lo a mirror finish.

### BRIEF DESCRIPTION OF THE DRAWINGS

FIG. 1 is schematic plain view of a LED signboard according to the prior art.

FIG. 2 is a sectional view taken along line A-A′ of FIG. 1.

FIG. 2A corresponds to FIG. 2, showing an alternate form of the arrangement of the LED light source.

FIG. 3 is an exploded view of a LED signboard according to the present invention.

FIG. 4 is a perspective assembly view of the LED signboard according to the present invention.

FIG. 5 is a back plain view of the LED signboard according to the present invention.

FIG. 6 is a sectional view in an enlarged scale of a part of FIG. 5.

FIG. 7 corresponds to FIG. 6, showing another installation arrangement of the LED light set in the base panel.

FIG. 8 is a schematic drawing of the present invention, showing the LED light set of the LED signboard turned on.

FIG. 9 is a sectional view in an enlarged scale of a part of FIG. 8.

FIG. 10 is a sectional view of a part of an alternate form of the present invention, showing the back wall of the base panel treated to mirror finish.

FIG. 11 is similar to FIG. 8, but showing different colors of LEDs used.

FIG. 12 is similar to FIG. 8, but showing a different arrangement of the LEDs of the LED light set and the arrangement of the LED light set with a controller.

FIG. 13 corresponds to FIG. 12, showing different colors of LEDs used.

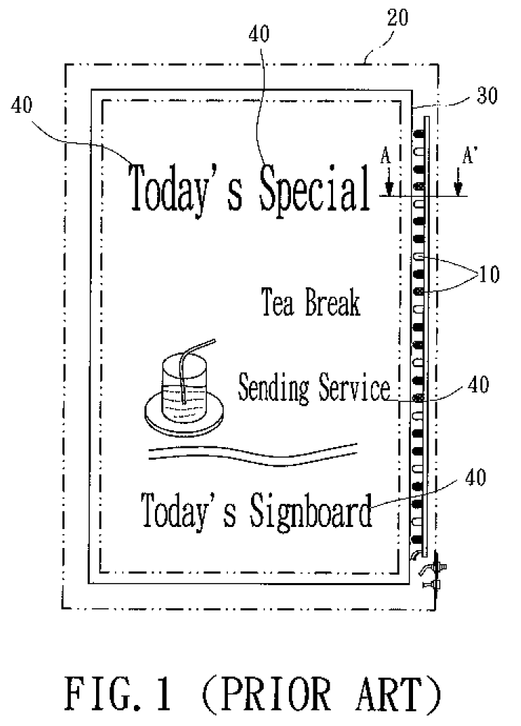

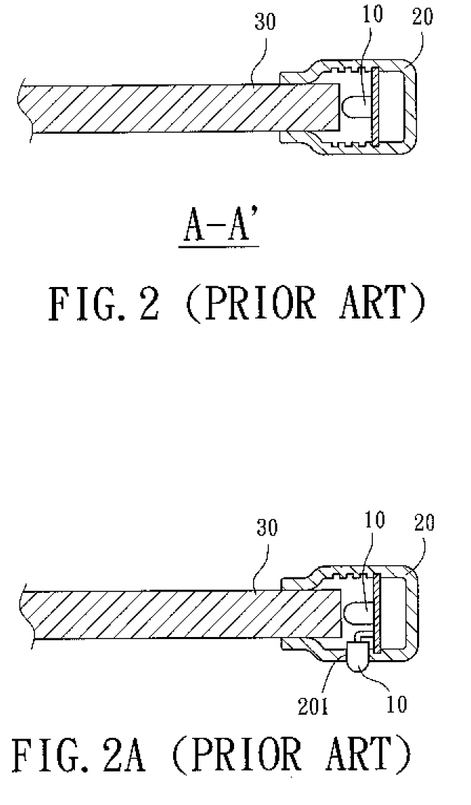

### DETAILED DESCRIPTION OF THE PREFERRED EMBODIMENT

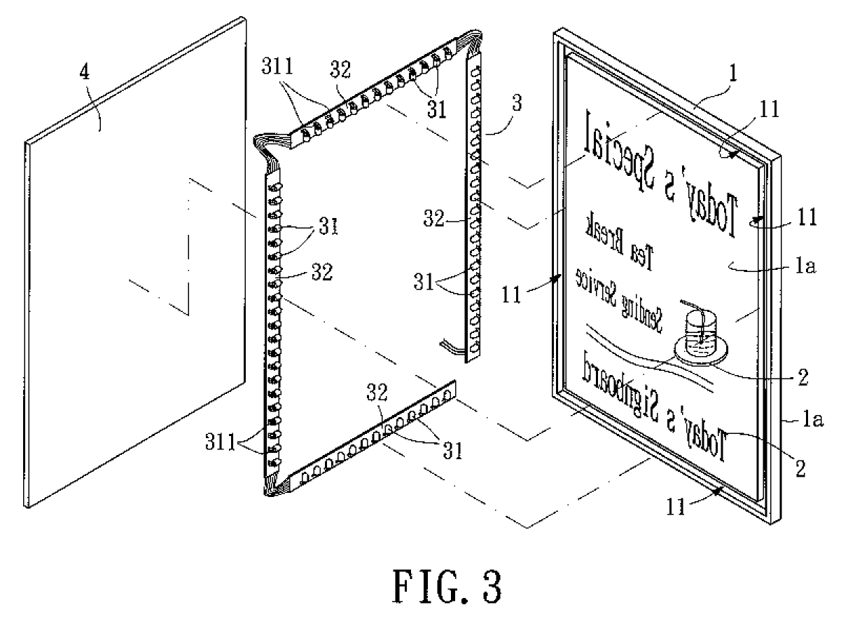

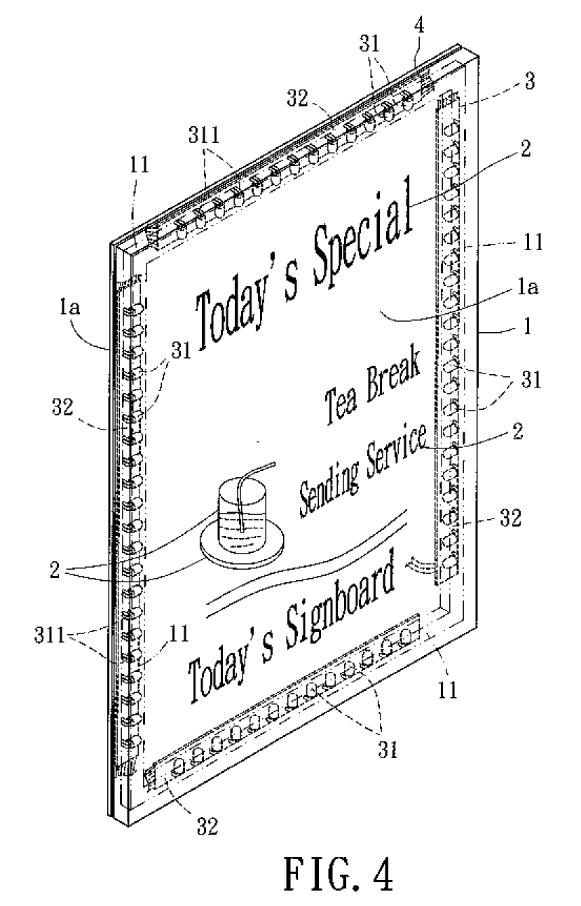

Referring to FIGS. 3-5, an LED signboard in accordance with the present invention is shown comprising a base panel 1 and a LED light set 3.

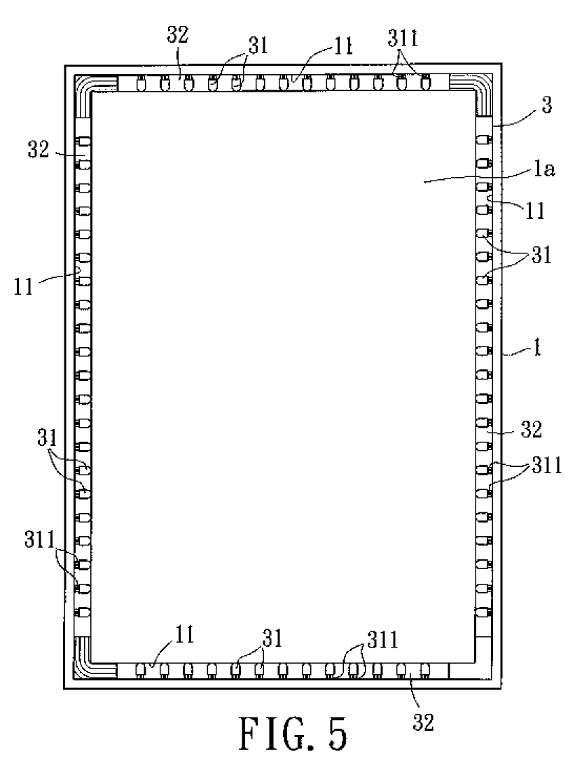

The base panel 1 is a transparent plate member made of acryl or glass, carrying a sign 2 that is formed in one of the front or back walls thereof. The sign 2 can be a design, notice, graphic devices blurb, etc., or their combination, and formed in the front or back wall of the base panel 1 by means of laser engraving, CNC etching, ink printing, fluorescent substance printing or writing or drawing. The base panel 1 further has a groove 11 formed in front or back wall, or both the front and hack walls. The groove 11 can be formed in the base panel 1 to show any of a variety of configurations. According to the embodiment shown in FIG. 5, the groove 11 is formed in the back wall 1a of the base panel 1 and straightly extending along the four sides of the base panel 1.

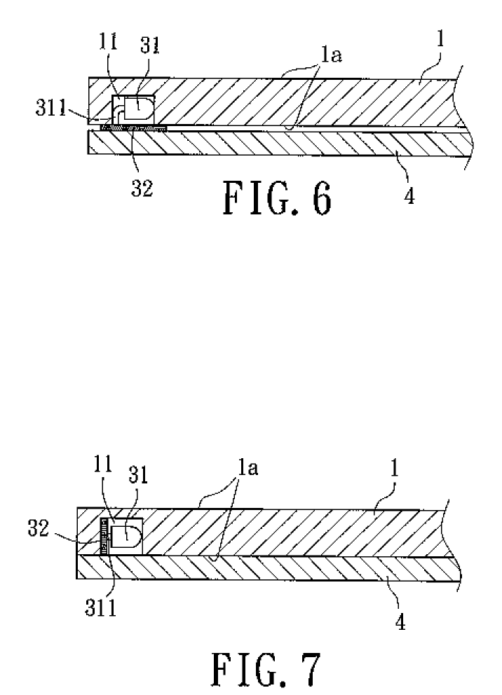

The LED light set 3 is mounted in the groove 11 of the base panel 1, comprising a plurality of substrate strips 32, and a plurality of LEDs (light emitting diodes) 31 mounted in the substrate strips 32. The LEDs 31 have the respective conducting pins 311 electrically connected to the circuits in the substrate strips 32. The LEDs 31 can be of one single color. Alternatively, the LEDs 31 can be of different colors. Further, the LED light set 3 can be arranged in the groove 11 of the base panel 1 so that the light emitting direction of the LEDs 31 is in parallel to the base panel 1. According to the embodiment shown in FIG. 6, the substrate strips 32 are mounted in the groove 11 of the base panel 1 in horizontal and the conducting pins 311 of the LEDs 31 are angled, so that the LEDs 31 can emit light in parallel to the base panel 1. According to the embodiment shown in FIG. 7, the substrate strips 32 are mounted in the groove 11 of the base panel 1 in vertical and the LEDs 31 are perpendicularly connected to the substrate strips 32 so that the LEDs 31 can emit light in parallel to the base panel 1. Further, an adhesive tape (not shown) may be used to seal the LED light set 3 to the inside of the groove 11 of the base panel 1. Further, the LED light set 3 may include switch means for operation control. Further, a battery pack or AC power adapter (not shown) may be used and electrically connected with the LED light set 3 to provide the necessary working voltage to the LED light set 3.

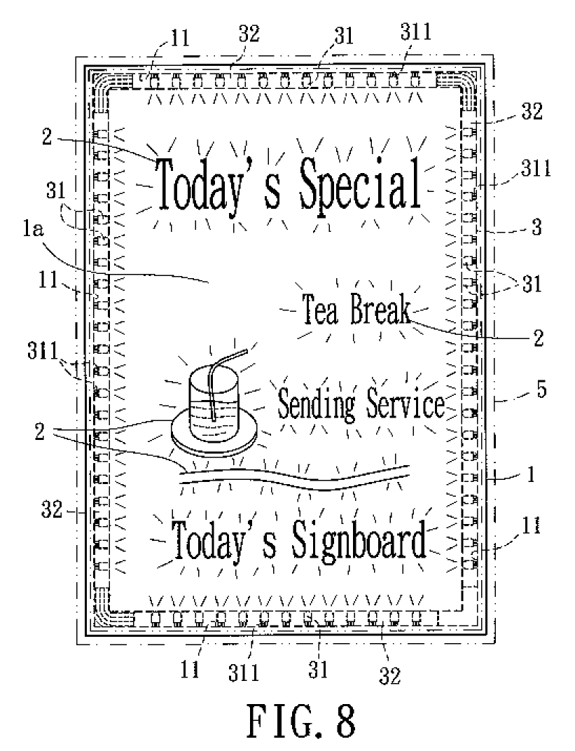

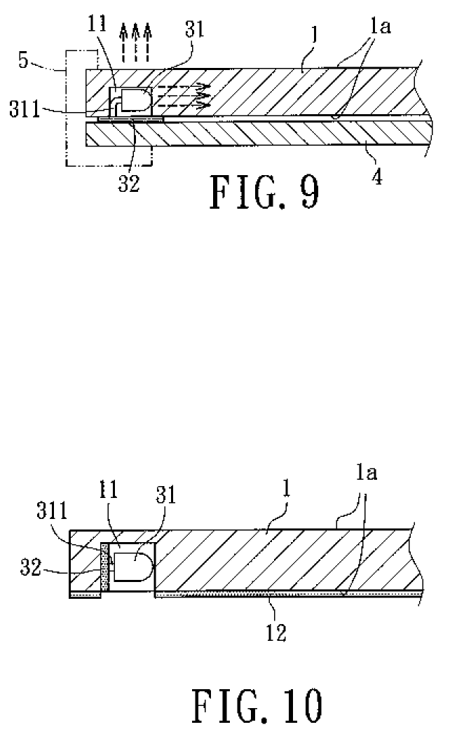

The LED signboard further comprises a back plate 4 covered on the back side of the base panel 1 (see FIGS. 3, 4, 6, 7 and 9), and a packing frame 5 fastened to the border area of the base panel 1 and the border area of the packing frame 5 (see FIGS. 8 and 9). When viewing from the front side of the base panel 1, the LEDs 31 are kept from sight, however the packing frame 5 does not block the glow of the LEDs 31, i.e., a glow of the LEDs 31 can he seen around the border area of the signboard when the LEDs 31 are turned on to illuminate the sign 2.

The back wall 1a of the base panel 1 may be treated to a mirror finish, for example, the back wall 1a of the base panel 1 can be coated with a layer of metal coating or adhered with a metal film 12. In this case, the aforesaid back plate 4 can be eliminated.

Further, the LED light set 3 can be installed in the groove 11 at the back wall of the base panel 1 at only one single lateral side of the base panel 1.

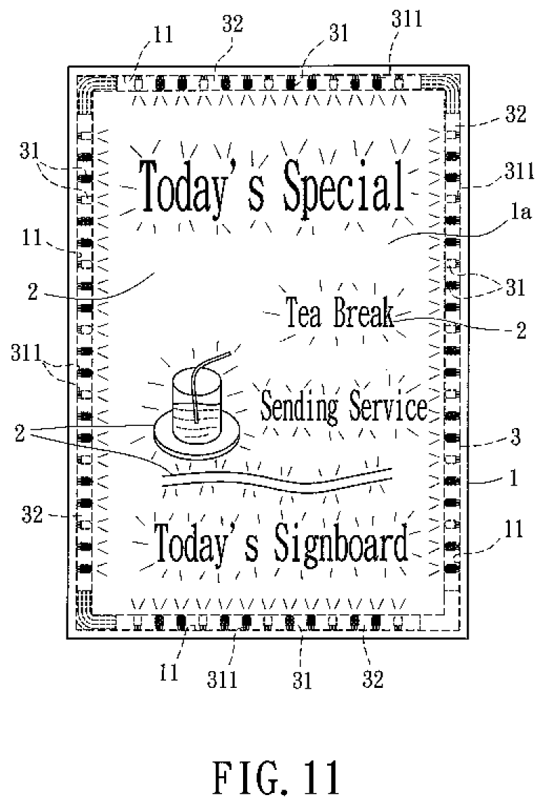

When power supply is switched on, the LEDs 31 emit light into the base panel 1 in parallel to the extending direction of the base panel 1, illuminating the sign 2. At the same time, the glow of the LEDs 31 illuminates the periphery of the signboard. Namely, the LEDs 31 can reach two illuminating effects on the signboard. In case a fluorescent material is employed to the sign 2, the fluorescent material is caused to produce light a particular color of light when the LEDs 31 are turned on to emit light. According to the embodiment shown in FIG. 8, the LEDs 31 are of one same color. According to the embodiment shown in FIG. 11, the LEDs 31 emit different colors of light. Further, the LEDs 31 can be controlled to flash subject to a predetermined flashing mode, producing a lighting effect.

Further, because the LEDs 31 are mounted inside the base panel 1 to emit light in a parallel manner relative to the base panel 1 and because the use of the packing frame 5 does not block the light of the LEDs 31, light from the LEDs 31 is diffused in the base panel 1, enhancing the illumination, and therefore the advertising or display effect of the sign 2 is enhanced.

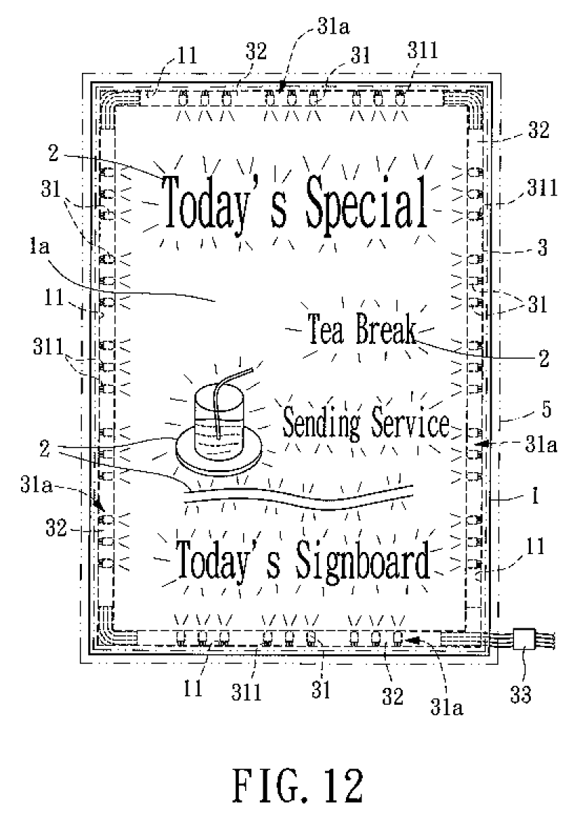

In the embodiment shown in FIG. 12, the LEDs 31 of the LED light set 3 are of one single color and arranged into multiple LED groups 31a. Each LED group 31a includes at least 2, for example, 3 LEDs 31. Furthers the LED light set 3 according to this embodiment comprises a programmable controller 33 for controlling the LED groups 31a to flash subject to a predetermined order and frequency. For example, the programmable controller 33 can be programmed to control flashing of the LED groups 31a around the border of the signboard in a proper order, or the LED groups 31a can be turned on/off in sequence with different pattern and frequency by the controlling of the programmable controller 33.

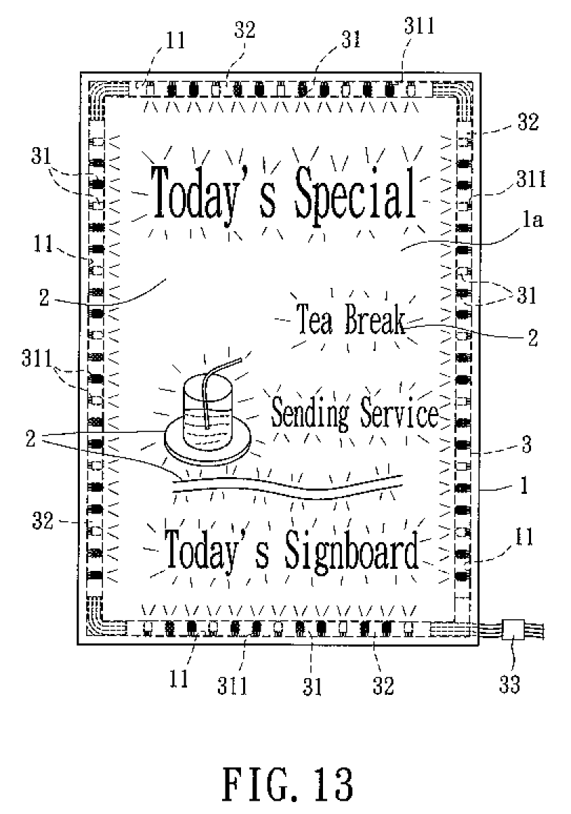

In the embodiment shown in FIG. 13, the LEDs 31 of the LED light set 3 have different colors. According to this embodiment, three different colors of LEDs are used. Further, the LED light set 3 comprises a programmable controller 33 for controlling the LEDs 31 to flash subject to a predetermined order and frequency. For example, the programmable controller 33 can be programmed to control flashing of the LED groups 31a around the border of the signboard in a proper order. During operation, the LEDs 31 emit light toward the inside of the base panel 1 to illuminate the sign 2 with different colors of light from different sides at different time intervals subject to the control of the programmable controller 33, and at the same time, a glow of the LEDs 31 runs around the periphery of the signboard, showing a lighting effect to attract people's eyes.

Although particular embodiments of the invention have been described in detail for purposes of illustration, various modifications and enhancements may be made without departing from the spirit and scope of the invention.

What the invention claimed is:

1. A LED signboard comprising:
a transparent base panel, said transparent base panel having at least one groove in at least one of front and back sides thereof; and
a LED light set mounted in said at least one groove of said transparent base panel and adapted for emitting light into said transparent base panel in parallel to the extending direction of said transparent base panel.

2. The LED signboard as claimed in claim 1, wherein said at least one groove is formed in the back side of said transparent base panel around the border of said transparent base panel.

3. The LED signboard as claimed in claim 1, wherein said LED light set comprises at least one substrate strip mounted in said at least one groove in parallel to the extending direction of said transparent base panel, and a plurality of light emitting diodes electrically connected to said at least one substrate strip and extending in parallel to the extending direction of said transparent base panel and adapted for emitting light into said transparent base panel.

4. The LED signboard as claimed in claim 1, wherein said LED light set comprises at least one substrate strip mounted in said at least one groove in a direction perpendicular to the extending direction of said transparent base panels and a plurality of light emitting diodes electrically connected to said at least one substrate strip and extending in parallel to the extending direction of said transparent base panel and adapted for emitting light into said transparent base panel.

5. The LED signboard as claimed in claim 1, further comprising a back plate covered on the back side of said transparent base panel.

6. The LED signboard as claimed in claim 5, further comprising a packing frame fastened to said transparent base panel and said back plate around the border area of said transparent base panel and said back plate.

7. The LED signboard as claimed in claim 1, wherein the back side of said transparent base panel has a mirror finish.

8. The LED signboard as claimed in claim 1, wherein said LED light set comprises a plurality of LED groups mounted in said at least one groove of said transparent base panel and arranged around the border of said transparent base panel, each said LED group comprising a number of light emitting diodes, said light emitting diodes are the same color, and a programmable controller adapted for controlling the flashing pattern and the flashing frequency of said light emitting diodes of said LED groups.

9. The LED signboard as claimed in claim 1, wherein said LED light set comprises a plurality of different colors of light emitting diodes mounted in said at least one groove of said transparent base panel and arranged around the border of said transparent base panel, and a programmable controller adapted for controlling the flashing pattern and the flashing frequency of said light emitting diodes of said LED groups.
